(19) United States
(12) Patent Application Publication
(10) Pub. No.: US 2014/0269509 A1
(43) Pub. Date: Sep. 18, 2014

(54) SYSTEM AND METHOD OF PUBLISHING SERVICE AVAILABILITY

(71) Applicant: QUALCOMM Incorporated, San Diego, CA (US)

(72) Inventor: Shyamal RAMACHANDRAN, San Diego, CA (US)

(73) Assignee: QUALCOMM INCORPORATED, San Diego, CA (US)

(21) Appl. No.: 14/207,291

(22) Filed: Mar. 12, 2014

Related U.S. Application Data
(60) Provisional application No. 61/790,571, filed on Mar. 15, 2013.
(60) Provisional application No. 61/793,004, filed on Mar. 15, 2013.

(51) Int. Cl. H04W 8/02

(52) U.S. Cl. CPC H04W 8/02
USPC 370/328

(57) ABSTRACT

Aspects of the present disclosure provided techniques for wireless communications, and more particularly, to techniques and apparatus for publishing service availability. According to certain aspects, a method for wireless communications by a user equipment (UE) is provided. The method generally includes providing status information to a presence server that the UE is available via the first network service, wherein the presence server is a network-based entity that provides presence status services for a plurality of destination devices including the UE, detecting one or more operational limitations that might prevent the UE from being available via the first network service, and updating the presence server, in response to the detecting, to indicate the UE is not available via the first network service.

### CLAIM OF PRIORITY UNDER 35 U.S.C. §119

This application claims benefit of U.S. Provisional Patent Application Ser. No. 61/790,571, filed Mar. 15, 2013, which is herein incorporated by reference in its entirety, and U.S. Provisional Patent Application Ser. No. 61/793,004, filed Mar. 15, 2013, which is herein incorporated by reference in its entirety.

### BACKGROUND

1. Field

Aspects of the present disclosure relate generally to wireless communications, and more particularly, to techniques and apparatus for publishing service availability.

2. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include code division multiple access (CDMA) networks, time division multiple access (TDMA) networks, frequency division multiple access (FDMA) networks, orthogonal FDMA (OFDMA) networks, and single-carrier FDMA (SC-FDMA) networks.

In some systems, packet-switched (PS) voice-services may be provided over a wireless network (e.g., voice over LTE or VoLTE). Prior to making a call, a mobile device (e.g., a user equipment or UE) may need to perform a random access procedure to synchronize with a network. Unfortunately, the random access procedure may delay call setup. If the network is non-responsive for some reason (e.g., excessive loading or the UE is at a cell edge), significant power may consumed to send repeated RACH requests, to no avail.

### SUMMARY

Aspects of the present disclosure relate to techniques and apparatus for publishing service availability.

Certain aspects of the present disclosure provide a method for wireless communications by a user equipment (UE). The method generally includes registering for at least a first network service, providing status information to a presence server that the UE is available via the first network service, wherein the presence server is a network-based entity that provides presence status services for a plurality of destination devices including the UE, detecting one or more operational limitations that might prevent the UE from being available via the first network service; and updating the presence server, in response to the detecting, to indicate the UE is not available via the first network service.

Certain aspects of the present disclosure provide a method for wireless communications. The method generally includes providing status information to a presence server that a user equipment (UE) is available via a first network service, wherein the presence server is a network-based entity that provides presence status services for a plurality of destination devices including the UE, detecting one or more operational limitations that might prevent the UE from being available via the first network service, and updating the presence server, in response to the detecting, to indicate the UE is not available via the first network service.

Certain aspects of the present disclosure provide an apparatus for wireless communications. The apparatus generally includes means for registering for at least a first network service, means for providing status information to a presence server that the UE is available via the first network service, wherein the presence server is a network-based entity that provides presence status services for a plurality of destination devices including the UE, means for detecting one or more operational limitations that might prevent the UE from being available via the first network service, and means for updating the presence server, in response to the detecting, to indicate the UE is not available via the first network service.

Certain aspects of the present disclosure provide an apparatus for wireless communications. The apparatus generally includes means for providing status information to a presence server that a user equipment (UE) is available via a first network service, wherein the presence server is a network-based entity that provides presence status services for a plurality of destination devices including the UE, means for detecting one or more operational limitations that might prevent the UE from being available via the first network service, and means for updating the presence server, in response to the detecting, to indicate the UE is not available via the first network service.

Certain aspects of the present disclosure provide an apparatus for wireless communications. The apparatus generally includes at least one processor configured to: register for at least a first network service, provide status information to a presence server that the UE is available via the first network service, wherein the presence server is a network-based entity that provides presence status services for a plurality of destination devices including the UE, detect one or more operational limitations that might prevent the UE from being available via the first network service, and update the presence server, in response to the detecting, to indicate the UE is not available via the first network service. The apparatus generally also includes a memory coupled with the at least one processor.

Certain aspects of the present disclosure provide an apparatus for wireless communications. The apparatus generally includes at least one processor configured to: provide status information to a presence server that a user equipment (UE) is available via a first network service, wherein the presence server is a network-based entity that provides presence status services for a plurality of destination devices including the UE, detect one or more operational limitations that might prevent the UE from being available via the first network service, and update the presence server, in response to the detecting, to indicate the UE is not available via the first network service. The apparatus generally also includes a memory coupled with the at least one processor.

Certain aspects of the present disclosure provide a computer program product for wireless communications. The computer program product generally includes a computer readable medium having instructions stored thereon for registering for at least a first network service, providing status information to a presence server that the UE is available via the first network service, wherein the presence server is a network-based entity that provides presence status services for a plurality of destination devices including the UE, detecting one or more operational limitations that might prevent the UE from being available via the first network service, and updating the presence server, in response to the detecting, to indicate the UE is not available via the first network service.

Certain aspects of the present disclosure provide a computer program product for wireless communications. The computer program product generally includes a computer readable medium having instructions stored thereon for providing status information to a presence server that a user equipment (UE) is available via a first network service, wherein the presence server is a network-based entity that provides presence status services for a plurality of destination devices including the UE, detecting one or more operational limitations that might prevent the UE from being available via the first network service, and updating the presence server, in response to the detecting, to indicate the UE is not available via the first network service.

Various aspects and features of the disclosure are described in further detail below.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an exemplary deployment in which multiple wireless networks have overlapping coverage, according to certain aspects of the present disclosure.

FIG. 2 illustrates a block diagram of a user equipment (UE) and other network entities, according to certain aspects of the present disclosure.

FIG. 3 illustrates an example call flow for publishing service availability, according to certain aspects of the present disclosure.

FIG. 4 illustrates example operations that may be performed by a UE, according to certain aspects of the present disclosure.

FIG. 5 illustrates example operations for wireless communications, according to certain aspects of the present disclosure.

### DETAILED DESCRIPTION

Techniques and apparatus are provided herein for publishing service availability of a user equipment (UE). A UE may determine that it is does not want to receive communications via a network service for which the UE is registered. For example, the service is no longer available or no longer preferred. In order to prevent the UE from receiving communications via the network service, the UE updates the Presence server that the UE is no longer available for the network service, although the UE may remain registered for that service.

The techniques described herein may be used for various wireless communication networks such as code division multiple access (CDMA), time division multiple access (TDMA), frequency division multiple access (FDMA), orthogonal FDMA (OFDMA), single carrier FDMA (SC-FDMA) and other networks. The terms “network” and “system” are often used interchangeably. A CDMA network may implement a radio access technology (RAT) such as universal terrestrial radio access (UTRA), cdma2000, etc. UTRA includes wideband CDMA (WCDMA) and other variants of CDMA. cdma2000 covers IS-2000, IS-95 and IS-856 standards. IS-2000 is also referred to as 1x radio transmission technology (1xRTT), CDMA2000 1X, etc. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP long-term evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and RATs mentioned above as well as other wireless networks and RATs. For clarity, certain aspects of the techniques are described below for LTE and 1xRTT.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

### Example Wireless Network

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for voice-over-Internet protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1xRTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

FIG. 2 shows a block diagram of a design of UE 110, eNB 108, and MME 126. At UE 110, an encoder 212 may receive traffic data and signaling messages to be sent on the uplink. Encoder 212 may process (e.g., format, encode, and interleave) the traffic data and signaling messages. A modulator (Mod) 214 may further process (e.g., symbol map and modulate) the encoded traffic data and signaling messages and provide output samples. A transmitter (TMTR) 222 may condition (e.g., convert to analog, filter, amplify, and frequency upconvert) the output samples and generate an uplink signal, which may be transmitted via an antenna 224 to eNB 108.

On the downlink, antenna 224 may receive downlink signals transmitted by eNB 108 and/or other eNBs/base stations. A receiver (RCVR) 226 may condition (e.g., filter, amplify, frequency downconvert, and digitize) the received signal from antenna 224 and provide input samples. A demodulator (Demod) 216 may process (e.g., demodulate) the input samples and provide symbol estimates. A decoder 218 may process (e.g., deinterleave and decode) the symbol estimates and provide decoded data and signaling messages sent to UE 110. Encoder 212, modulator 214, demodulator 216, and decoder 218 may be implemented by a modem processor 210. These units may perform processing in accordance with the RAT (e.g., LTE, 1 xRTT, etc.) used by the wireless network with which UE 110 is in communication.

A controller/processor 230 may direct the operation at UE 110. Controller/processor 230 may also perform or direct other processes for the techniques described herein. Controller/processor 230 may also perform or direct the processing by UE 110 in FIGS. 3 and 4. Memory 232 may store program codes and data for UE 110. Memory 232 may also store a priority list and configuration information.

At eNB 108, a transmitter/receiver 238 may support radio communication with UE 110 and other UEs. A controller/processor 240 may perform various functions for communication with the UEs. On the uplink, the uplink signal from UE 110 may be received via an antenna 236, conditioned by receiver 238, and further processed by controller/processor 240 to recover the traffic data and signaling messages sent by UE 110. On the downlink, traffic data and signaling messages may be processed by controller/processor 240 and conditioned by transmitter 238 to generate a downlink signal, which may be transmitted via antenna 236 to UE 110 and other UEs. Controller/processor 240 may also perform or direct other processes for the techniques described herein. Controller/processor 240 may also perform or direct the processing by eNB 102 in FIGS. 3 and 4. Memory 242 may store program codes and data for the base station. A communication (Comm) unit 244 may support communication with MME 126 and/or other network entities.

At MME 126, a controller/processor 250 may perform various functions to support communication services for UEs. Controller/processor 250 may also perform or direct the processing by MME 126 in FIGS. 3 and 4. Memory 252 may store program codes and data for MME 126. A communication unit 254 may support communication with other network entities.

FIG. 2 shows simplified designs of UE 110, eNB 108, and MME 126. In general, each entity may include any number of transmitters, receivers, processors, controllers, memories, communication units, and other type suitable components.

### Example System and Method of Publishing Service Availability

Aspects of the present disclosure may be utilized to help deliver a better overall user experience in a wireless communications to a user of a wireless device or those trying to reach that user. By updating a Presence server intelligently (e.g., based on certain triggering events), certain scenarios may be avoided where the user's status is shown as being available to be reached via certain services when, for some reasons, they are not.

The example embodiments described herein are described as performed by a user equipment (UE), however, it is to be understood that in some embodiments, the actions may be performed by a network, for example, a base station or other network entity.

A UE may successfully register certain UE service domains, such as Internet Protocol multimedia services (IMS) voice or voice over long term evolution (VoLTE). The UE may then update a Presence server of its availability, for example, for incoming mobile terminated (MT) VoLTE calls. The Presence server then updates all contacts (e.g., other UEs, also referred to as “watchers”) of the UE's availability.

Other UEs or users may then place a VoLTE call to the UE based on the fact that the UE's presence is known and the UE is advertised by the Presence server as “available for VoLTE calls.”

However, in certain instances, it is possible that the UE may be registered for certain services, but the UE may not actually be available for the registered services. In one example, the UE may be registered for Vo, for example, may not be able to accept VoLTE calls. In such cases, it is desirable that the UE is able to update the Presence that it is no longer available for VoLTE. The UE can perform IMS deregistration and re-registration procedures, however, this requires additional signaling and impacts all services including non-real-time services.

Techniques and apparatus are provided herein for updating a Presence server, by a UE, of the UEs unavailability for a network service while remaining registered for the service, which may allow services to continue seamlessly.

According to certain aspects, the UE may update presence information based on RAN level procedure outcome or domain selection function outcome. In one example embodiment, a UE may be camped in a network where VoLTE services are available. The UE may execute a domain selection function and select VoLTE as the preferred voice domain (e.g., by registering for IMS). Thereafter, the UE may update the Presence server with information about the UE's availability for VoLTE calling.

After registering for IMS and updating the Presence server of the UE's availability for VoLTE calls, the UE may become unavailable for VoLTE or VoLTE may become undesirable. According to certain aspects, the UE may remain IMS registered but inform the Presence server that the UE is no longer available to receive VoLTE calls. Such instances (i.e., “triggers”) may include network capability limitations, device capability limitations, and limitations in current radio or network conditions that may impact the UE's availability or desirability for the particular service—in this example, VoLTE calls.

In another example scenario, the UE may be registered for SMS and Voice with the IMS core. However, after registering for SMS and Voice, the UE may transition to a tracking area or routing area where voice over IMS is not supported. The may update the Presence server accordingly, that the UE is no longer available for Voice calls. By updating the Presence server that the UE is unavailable for VoLTE calls, but remaining IMS registered, the UE may continue to use IMS or SMS, while avoiding VoLTE calls.

A UE registered for a certain service (e.g., IMS voice) that moves away from a region that supports the service to a region that does not support the particular service may be one example of a network capability limitation trigger. Alternatively, in a different scenario, a UE may prefer a particular service (e.g., circuit-switched (CS) voice) as a primary service and a different service (e.g., IMS voice) as a secondary preferred service. The UE may move from an area where CS voice was not available—but packet-switched (PS) voice was available—to an area where CS voice becomes available. After moving to the cell supporting CS voice, the UE may switch to the preferred CS voice and update the Presence server that the UE is not available for IMS voice, while remaining IMS registered. In both examples, when the UE moves to the second region or area, the UE may prefer to remain registered with the IMS core but prevent the use of VoLTE for voice calls.

Video telephony may require support for multiple bearers for separate handling of video and voice traffic (e.g., at least two, one for video, one for voice). In another example of a network capability limitation trigger, the UE may support multiple bearers (i.e., support video telephony) on EUTRAN, but not on UTRA/GERAN (i.e., does not support video telephony). The UE may be registered for video and voice traffic and may move from EUTRAN to UTRAN/GERAN. In this case, the UE may indicate availability for voice telephony while on the EUTRAN, but may update the Presence server that the UE is unavailable for voice telephony when moving to UTRAN/GERAN. In an aspect, the UE may retain availability for one of the services, for example, voice.

Alternatively, the UE may be registered for SMS, voice, and video telephony over IMS. When the UE transitions to UTRAN/GERAN, where multiple radio access bearer configurations are no longer supported, the UE may update the Presence server of the UE's unavailability for video telephony, while remaining IMS registered. By remaining registered, the UE may continue to be available for SMS and voice, while preventing video telephony.

According to certain aspects, the UE may update the Presence server based on a device capability limitation trigger. For example, dual radio UEs (e.g., UEs that support simultaneous 1xRTT and EUTRAN transmission) may encounter coexistence restrictions depending on the serving bands on the 1xRTT and EUTRAN radios. Depending on the serving 1xRTT channel, the UE may need to drop the ongoing EUTRAN connection in order to execute capability change procedures. In this example, in order to avoid bad user experience, the UE may prevent any real time applications from being impacted by local connection drops by advertising the UE's unavailability for real time services by updating its presence information to the Presence server.

In an aspect, the UE may be registered for SMS, Voice, and Video Telephony over IMS. A traffic connection may be set up over 1xRTT. The UE may update the Presence server that it is not available for IMS real-time services such as Voice and Video Telephony. The UE may also route mobile-originated (MO) calls over 1xRTT so as to prevent disruption to such real time services if the need arises to drop an LTE call in order to perform mode change if the 1xRTT radio moves to a channel/band that interferes with the current LTE band.

According to certain aspects, current radio or network conditions may trigger the UE to update the Presence server. In one example of a limitation on current radio or network conditions trigger, the network may be unable to support a quality of service (QoS) needed (e.g., data rate, latency, etc.) for a given service. For example, the UE may be unable to make video telephony calls when on the edge of coverage. The determination may be made based on radio conditions (e.g., serving cell strength).

FIG. 3 illustrates an example call flow 300 for publishing service availability, according to certain aspects of the present disclosure. As shown in FIG. 3, in a first step 312, the UE 310 may perform normal RAN level or EPC level procedures between the UE 310 and the RAN/EPC 302. The RAN or EPC level procedures may motivate the UE to modify or update presence information with the Presence server, for example, based on the specific triggers discussed above.

In a second step 314, the UE 310 may execute domain selection functions that result in the need to inform the Presence server 306 that the UE 310 is not available for one or more services.

In a third step 316, for example based on one of the triggers discussed above, the UE may compose a Publish message and may send the message to the Presence server 306 via the IMS core 304.

In a fourth step 318, the Presence server 306 may update the UE's 110 presence information based on the Publish message received from the UE 110 and may acknowledge the changes, for example, by sending a 200 OK message to the UE 310.

In a fifth step 320, the Presence server 306 may send updated presence information to the watchers.

FIG. 4 illustrates example operations 400 for wireless communications, in accordance with certain aspects of the present disclosure. The operations 400 may be performed, for example, by a UE (e.g., UE 110), to intelligently update a Presence server.

The operations 400 may begin, at 402, by registering for at least a first network service (e.g., IMS, VoLTE, SMS, Video Telephony, etc.). For example, in some embodiments, the UE may perform a domain selection function. At 404, the UE may provide status information to a Presence server that the UE is available via the first network service, wherein the Presence server is a network-based entity that provides presence status services for a plurality of destination devices including the UE. For example, as previously mentioned, the UE may send a Publish message to the Presence server via the IMS core indicating the outcome of the domain selection function (e.g., for which of the network services the UE is available).

At 406, the UE may detect one or more operational limitations that might prevent the UE from being available via the first network service. A detected operational limitation may include any of the triggers mentioned above, for example, network capability limitations, device capability limitations, and limitations in current radio or network conditions. At 408, the UE may update the Presence server, in response to the detecting, to indicate the UE is not available via the first network service.

In some embodiments, the UE may update the Presence server that it is not available via the first network service while remaining registered for that service. For example, in the specific embodiment discussed above, a UE registered for SMS and VoLTE services in IMS, may move from a region that supports VoLTE to a region that does not support VoLTE. The UE may update its presence information by sending a Publish message to the Presence server indicating that the UE is unavailable for VoLTE calls, but the UE may remain registered in IMS such it may still be available for SMS. According to certain aspects, the Presence server may then advertise the UE's unavailability for VoLTE calls to all watchers.

FIG. 5 illustrates example operations 500 for wireless communications, in accordance with certain aspects of the present disclosure. The operations 500 may be performed by a network entity, for example, by a base station (BS) (e.g., eNB 108), to intelligently update a Presence server.

The operations 500 may begin, at 502, by providing status information to a Presence server that a UE is available via a first network service, wherein the Presence server is a network-based entity that provides presence status services for a plurality of destination devices including the UE. At 504, the network may detect one or more operational limitations that might prevent the UE from being available via the first network service. At 506, the network may update the Presence server, in response to the detecting, to indicate that the UE is not available via the first network service.

As used herein, a phrase referring to “at least one of” a list of items refers to any combination of those items, including single members. As an example, “at least one of: a, b, or c” is intended to cover: a, b, c, a-b, a-c, b-c, and a-b-c.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communications by a user equipment (UE), comprising:
registering for at least a first network service;
providing status information to a presence server that the UE is available via the first network service, wherein the presence server is a network-based entity that provides presence status services for a plurality of destination devices including the UE;
detecting one or more operational limitations that might prevent the UE from being available via the first network service; and
updating the presence server, in response to the detecting, to indicate the UE is not available via the first network service.

2. The method of claim 1, wherein the first network service comprises a service provided via Internet Protocol Multimedia Subsystem (IMS).

3. The method of claim 2, wherein updating the presence server comprises:
updating the presence server to indicate the UE is not available via the first network service but is still available via a second network service also provided via IMS.

4. The method of claim 1, wherein the detecting comprises:
detecting a move of the UE from a first region where the first network service is supported to a second region where the first network service is not supported.

5. The method of claim 4, wherein:
the first network service requires support for multiple bearers for separate handling of video and voice traffic; and
the detecting comprises detecting a move of the UE from the first region where the UE is able to support multiple bearers to the second region where the UE is not able to support multiple bearers.

6. The method of claim 5, wherein:
the first network service comprises video telephony; and
updating the presence server comprises updating the presence server to indicate the UE is not available via video telephony calls but is still available via voice calls.

7. The method of claim 1, wherein the detecting comprises:
detecting a move of the UE from a first region where a second network service, preferred over the first network service, is not available to a second region where the second network service is available.

8. The method of claim 1, wherein:
the UE comprises a dual radio UE that supports communications via at least two radio access technologies (RATs); and
the detecting comprises detecting one or more operational limitations caused by coexistence restrictions.

9. The method of claim 1, wherein the detecting comprises:
detecting at least one of a current radio condition or current network condition that prevents the UE from using the first network service.

10. The method of claim 9, wherein the detecting comprises:
detecting the UE is unable to support a quality of service (QoS) requirement for the first network service.

11. The method of claim 1, wherein updating the presence server comprises indicating the UE is not available via the first network service without de-registering for the first network service.

12. A method for wireless communications, comprising:
providing status information to a presence server that a user equipment (UE) is available via a first network service, wherein the presence server is a network-based entity that provides presence status services for a plurality of destination devices including the UE;
detecting one or more operational limitations that might prevent the UE from being available via the first network service; and
updating the presence server, in response to the detecting, to indicate the UE is not available via the first network service.

13. The method of claim 12, wherein the first network service comprises a service provided via Internet Protocol Multimedia Subsystem (IMS).

14. The method of claim 13, wherein updating the presence server comprises:
updating the presence server to indicate the UE is not available via the first network service but is still available via a second network service also provided via IMS.

15. The method of claim 12, wherein the detecting comprises:
detecting a move of the UE from a first region where the first network service is supported to a second region where the first network service is not supported.

16. The method of claim 15, wherein:
the first network service requires support for multiple bearers for separate handling of video and voice traffic; and
the detecting comprises detecting a move of the UE from the first region where the UE is able to support multiple bearers to the second region where the UE is not able to support multiple bearers.

17. The method of claim 16, wherein:
the first network service comprises video telephony; and
updating the presence server comprises updating the presence server to indicate the UE is not available via video telephony calls but is still available via voice calls.

18. The method of claim 12, wherein the detecting comprises:
detecting a move of the UE from a first region where a second network service, preferred over the first network service, is not available to a second region where the second network service is available.

19. The method of claim 12, wherein:
the UE comprises a dual radio UE that supports communications via at least two radio access technologies (RATs); and
the detecting comprises detecting one or more operational limitations caused by coexistence restrictions.

20. The method of claim 12, wherein the detecting comprises:
detecting at least one of a current radio condition or current network condition that prevents the UE from using the first network service.

21. The method of claim 20, wherein the detecting comprises:
detecting the UE is unable to support a quality of service (QoS) requirement for the first network service.

22. The method of claim 12, wherein updating the presence server comprises indicating the UE is not available via the first network service without de-registering for the first network service.

23. An apparatus for wireless communications by a user equipment (UE), comprising:
means for registering for at least a first network service;
means for providing status information to a presence server that the UE is available via the first network service, wherein the presence server is a network-based entity that provides presence status services for a plurality of destination devices including the UE;
means for detecting one or more operational limitations that might prevent the UE from being available via the first network service; and
means for updating the presence server, in response to the detecting, to indicate the UE is not available via the first network service.

24. The apparatus of claim 23, wherein the first network service comprises a service provided via Internet Protocol Multimedia Subsystem (IMS).

25. The apparatus of claim 24, wherein updating the presence server comprises:
updating the presence server to indicate the UE is not available via the first network service but is still available via a second network service also provided via IMS.

26. The apparatus of claim 23, wherein updating the presence server comprises indicating the UE is not available via the first network service without de-registering for the first network service.

27. An apparatus for wireless communications, comprising:
means for providing status information to a presence server that a user equipment (UE) is available via a first network service, wherein the presence server is a network-based entity that provides presence status services for a plurality of destination devices including the UE;
means for detecting one or more operational limitations that might prevent the UE from being available via the first network service; and
means for updating the presence server, in response to the detecting, to indicate the UE is not available via the first network service.

28. The apparatus of claim 27, wherein the first network service comprises a service provided via Internet Protocol Multimedia Subsystem (IMS).

29. The apparatus of claim 28, wherein updating the presence server comprises:
updating the presence server to indicate the UE is not available via the first network service but is still available via a second network service also provided via IMS.

30. The apparatus of claim 27, wherein updating the presence server comprises indicating the UE is not available via the first network service without de-registering for the first network service.
